(19) United States
(12) Patent Application Publication
(10) Pub. No.: US 2009/0078004 A1
(43) Pub. Date: Mar. 26, 2009

(54) Control for I. S. machine

(76) Inventors: John P. Moriarty, Longmeadow, MA (US); Kevin Moriarty, Hampden, MA (US)

Correspondence Address: REINHART BOERNER VAN DEUREN S.C.;ATTN: LINDA KASULKE, DOCKET COORDINATOR, 1000 NORTH WATER STREET, SUITE 2100, MILWAUKEE, WI, 53202, US

(21) Appl. No.: 11/903,248

(22) Filed: Sep. 20, 2007

(51) Int. Cl. C03B 9/41

(52) U.S. Cl. 65/160

(57) ABSTRACT

An I. S. Machine has a plurality of sections each of which has a controller located with the blank side operator interface which receives a sync signal from a machine control and data from a machine data server. The controller operates the section in accordance with a number of cycles commanded by an operator via blank and blow side interfaces.

The present invention relates to I. S. machines which transform gobs of glass into glass containers in a two-step process, and more particularly, to the electronic control for such machines.

### BACKGROUND OF THE INVENTION

An I. S. Machine is defined by a plurality of individual identical sections. Each section receives gobs of molten glass through the open top of a closed blank mold. A baffle mechanism is then displaced to close the blank mold whereupon air is blown into the mold to settle the gob in the mold. The gob is then formed into a parison either in a blow process where pressurized air is blown up into the molten gob to form the parison or in a press process where a plunger is displaced vertically upwardly into the gob. Cooling wind can pass through the blank molds to cool the outer surface of the parison and when the surface has been suitably chilled, the baffle will be removed and the blank molds will open. The parison will be transferred, by a transfer mechanism, to a location where blow molds can be closed around the parison. A blow head will be located on top of the blow molds and the parison will be blown into a bottle. Cooling air will be passed through the blow mold to chill the outer surface of the formed bottle and when it has been sufficiently chilled, the blow head will be removed, the blow molds will be opened and the bottle will be removed from the section and deposited on a dead plate by a take out mechanism.

A defined run cycle controls each of the sections with cycles starting at suitable offsets per a desired firing order. During a run cycle, each mechanism will be advanced and retracted (electrically operated solenoids, which control pneumatic mechanisms, or servo motors will be turned “on” and “off”) and all process air, like blank mold cooling will be turned “on” and “off”. Each of these state changes is called an “event” and a run cycle defines the time in a cycle when each event occurs. A timing control carries out such a cycle program.

One of the first electronically timed I. S. Machines was developed by Ball Corporation and is disclosed in U.S. Pat. No. 3,762,907. The Ball design controlled a pneumatically operated I. S. Machine and had solenoid operated valves at each section and a remote control room housing an electronic timing control. For the past 35 years, every electronic timing system has had this design:

Emhart Glass: U.S. Pat. No. 3,905,793;

Owens-Illinois: U.S. Pat. Nos. 6,212,909, 7,017,373;

Maul: U.S. Pat. No. 5,247,450

Hermann Heye: U.S. Pat. No. 7,054,710

Bottero: U.S. Patent Publication No. 2002/0052669

Vitro: U.S. Pat. No. 4,783,746

### OBJECT OF THE INVENTION

It is an object of the present invention to provide an improved I.S. Machine electronic control architecture.

Other objects and advantages of the present invention will become apparent from the following portion of this specification and from the accompanying drawings, which illustrate, in accordance with the mandate of the patent statutes, a presently preferred embodiment incorporating the principles of the invention.

### BRIEF DESCRIPTION OF THE DRAWINGS

FIG. 1 is a schematic oblique view of an I. S. Machine made in accordance with the teachings of the present invention; and

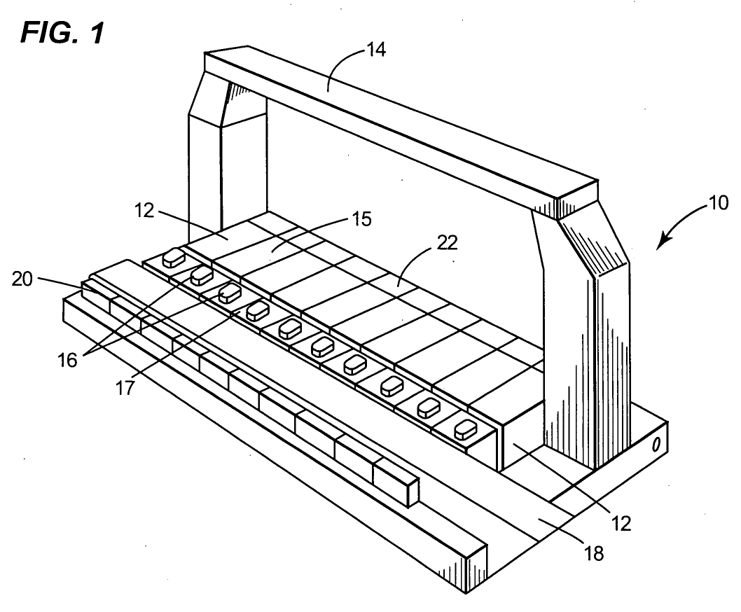

FIG. 2 is a schematic showing of the stand alone electronically timed control for each machine section.

### BRIEF DESCRIPTION OF THE PREFERRED EMBODIMENT

The disclosed I. S. Machine 10 has ten self-contained sections 12, which are straddled by an overhead beam 14, which supports a gob distributor (not shown). Each self-contained section has a section assembly 15. “Section assembly” when used herein and as schematically illustrated as a box, includes a section frame or “box” and those section mechanisms that are mounted on the section frame, i.e., a blank station mold open and close mechanism, a baffle mechanism, a blow station mold open and close mechanism, a mechanism for transferring a parison formed at the blank station to the blow station, a blow head mechanism, and a takeout mechanism for transferring a bottle formed at the blow station to a dead plate. As shown, pusher mechanisms 16 transfer the bottles deposited on the dead plates 17, onto a moving conveyor 18.

Each of the “N” sections has its own Control 19, which operates the mechanisms and air processes for that section pursuant to the event programs that define the desired cycles of the section. Each Control has a number of external connections: Timing Signals from External Timing and Delivery Signals 21; Data (set up, configuration including offsets, and diagnostics) from a Data Server 23; Power from a Power Source 25 (which could for example, be DC Power) and Data to and from an Auxiliary User Interface 27 (hand held terminal, for example). The Control 19 has two portions. On the operator's side of the conveyor is a blow side control portion 20 and on the other side of the machine is a blank side control portion 22.

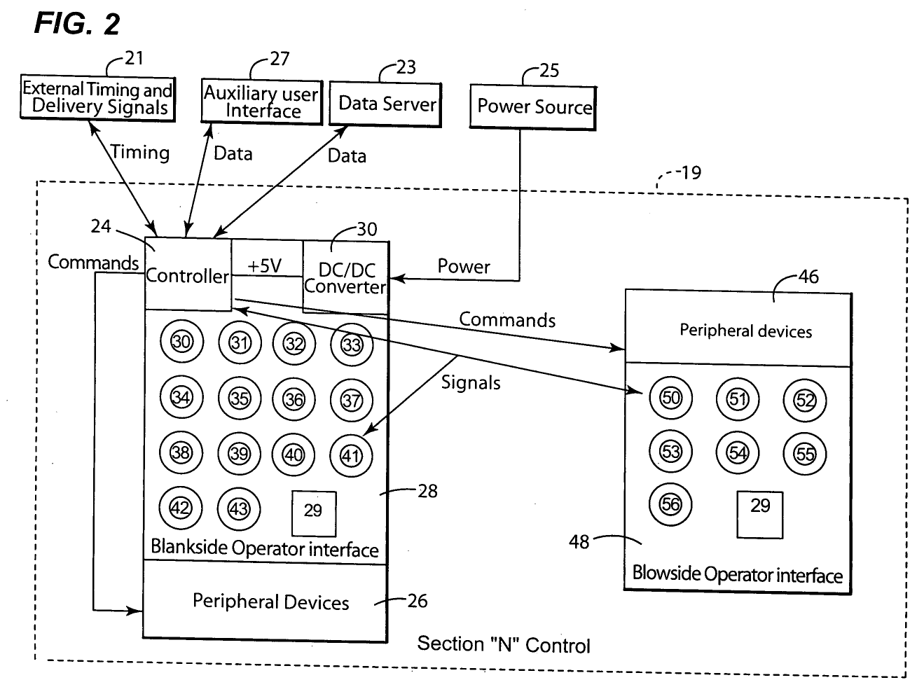

The blank side control portion 22 and the blow side control portion 20 for each section 12 of the I. S. Machine are shown in FIG. 2. The blank side portion 22 includes a Blank Side Operator Interface 28, which has a number of operator actuated buttons. The blank side control portion also has a Controller 24 which can operate programmed section cycles such as “normal start” 32, where the section will operate to produce containers (one button is shown but there would be two), normal stop 30, alternate stop 31, delivery 33, hot end ware reject 1,2 (34,35—assuming double gob operation), cold blank 36, swab 37, Blank Open/Close 38, Blank Disable 39, Baffle Up/Down 40, Baffle Disable 41 and Plunger 1,2 Up/Down 42,43. These cycles are representative, but not intended either to be the exact cycles present or to be all of the cycles that would be present. These cycles can only be started by an operator at the section. While shown as buttons the buttons could take other forms such as a touch screen input. An input 29 for the Auxiliary User Interface 27 can also be located on this interface.

The Controller 24 is powered by a Power Supply 30 (supplied power from a Power Source 27), which could supply +5V via a DC/DC Converter 30 (+18-+32V to +5V @3 Amps, for example). The Controller 24 is synchronized by Sync Signals from an external Machine Control 21 and performs these cycles by supplying Commands to Peripheral Devices 26 in the blank side control portion 22 and Peripheral Devices 46 in the blow side control portion 20 of the section control 19 or by sending a Delivery Signal to the Machine Control 21.

The blow side section control portion 20, also includes a Blow Side Control Operator Interface 48. This Blow Side Control Interface also has buttons that start cycles only to be started by an operator while at the section, i.e., normal stop 50, alternate stop 51, normal start 52 (one is shown but there would be two), and delivery 53, cold blank 54, or neck ring change 55, and blow head down 56. These buttons are representative, but not intended either to be the exact cycles present or to be all the cycles that would be present.

In an I. S. Machine having pneumatically operated mechanisms, the Peripheral devices can be solenoid operated valves operated by digital I/O commands and these solenoid operated valves can be individually located or located within a valve block. In a machine having servo operated mechanisms, the Peripheral devices can be servos and the commands can be analog or bus communications, for example.

1. An I. S. Machine for forming gobs of molten glass into glass containers comprising a plurality of sections each including
a section assembly having a plurality of displaceable mechanisms,
a section control for displacing the plurality of section mechanisms pursuant to selected cycles,
said section control having a blank side control portion and a blow side control portion,
said blank side control portion including
a plurality of peripheral devices,
a controller, and
an operator interface including a plurality of buttons operable by an operator to supply signals to said controller to run selected of said cycles, and
said blow side section control portion including
a plurality of peripheral devices, and
an operator interface including a plurality of buttons operable by an operator to supply signals to said controller to run selected of said cycles,
said controller comprising means for supplying commands to said plurality of peripheral devices to run said selected cycles,
a data server for supplying data to the controller of each of said sections, and
an external timing means for supplying sync signals to the controller of each of said sections.

2. An I. S. Machine for forming gobs of molten glass into glass containers according to claim 1, wherein one of said cycles is cold blanks.

3. An I. S. Machine for forming gobs of molten glass into glass containers according to claim 1, wherein at least one of said peripheral devices is a solenoid operated solenoid.

4. An I. S. Machine for forming gobs of molten glass into glass containers according to claim 1, wherein at least one of said peripheral devices is a servo motor.
